(19) United States
(12) Patent Application Publication
(10) Pub. No.: US 2026/0227804 A1
(43) Pub. Date: Aug. 6, 2026

(54) CONTROL METHOD FOR MOVING BODY, PROGRAM, AND INFORMATION PROCESSING DEVICE

(71) Applicant: MITSUBISHI HEAVY INDUSTRIES, LTD., Tokyo (JP)

(72) Inventors: Hirotaka Okazaki, Tokyo (JP); Naoki Yamada, Tokyo (JP); Kenji Takao, Tokyo (JP)

(73) Assignee: MITSUBISHI HEAVY INDUSTRIES, LTD., Tokyo (JP)

(21) Appl. No.: 19/152,586

(22) PCT Filed: Sep. 22, 2023
(86) PCT No.: PCT/JP2023/034388

§ 371 Date: Jul. 31, 2025

(30) Foreign Application Priority Data
Mar. 27, 2023 (JP) 2023-050305

(51) Int. Cl. G05D 1/693; B66F 9/06; B66F 17/00; G05D 1/622; G05D 105/28; G05D 107/70; G05D 109/10

(52) U.S. Cl. CPC G05D 1/693; B66F 9/063; B66F 17/003; G05D 1/622; G05D 2105/28; G05D 2107/70; G05D 2109/10

(57) ABSTRACT

According to the present invention, deadlock is suppressed or eliminated. This control method comprises: a step for acquiring first moving body information that includes the position and the speed of a first moving body, which is a manned vehicle; a step for setting a first region for prohibiting entry of an unmanned vehicle around the first moving body, on the basis of the first moving body information; a step for acquiring second moving body information that includes the position of a second moving body, which is an unmanned vehicle; a step for stopping the second moving body when the position of the second moving body that is indicated by the second moving body information is within a predetermined distance range from the first region; a step for notifying a driver of the first moving body of a retreat command to retreat to another location when the second moving body has stopped; a step for acquiring retreat completion information that indicates that the first moving body has stopped at a retreat destination; and a step for, upon acquiring the retreat completion information, setting a second region for prohibiting entry of an unmanned vehicle around the first moving body, so that said second region is narrower than the first region.

### TECHNICAL FIELD

The present disclosure relates to a control method for a moving body, a program, and an information processing device.

### BACKGROUND ART

Control for suppressing interference between moving bodies is known. For example, PTL 1 discloses that a permitted travel section is set for an unmanned vehicle that autonomously travels in a mine, and when a manned vehicle approaches the permitted travel section, a warning is sent to the manned vehicle to avoid interference between the manned vehicle and the unmanned vehicle.

### CITATION LIST

### Patent Literature

[PTL 1] Japanese Unexamined Patent Application Publication No. 2021-162976

### SUMMARY OF INVENTION

### Technical Problem

However, for example, in a case where a destination of the manned vehicle is located in a direction in which the unmanned vehicle is located and a destination of the unmanned vehicle is located in a direction in which the manned vehicle is located, even if the interference can be avoided, deadlock may occur because the manned vehicle and the unmanned vehicle cannot move toward the destinations. Therefore, it is required to suppress or eliminate deadlock when the manned vehicle and the unmanned vehicle are moving.

An object of the present disclosure is to provide a control method for a moving body, a program, and an information processing device capable of suppressing or eliminating deadlock when a manned vehicle and an unmanned vehicle are moving.

### Solution to Problem

A control method for a moving body according to the present disclosure includes a step of acquiring first moving body information including a position and a speed of a first moving body that is a manned vehicle, a step of setting a first region, where an unmanned vehicle is prohibited from entering, around the first moving body based on the first moving body information, a step of acquiring second moving body information including a position of a second moving body that is an unmanned vehicle, a step of stopping the second moving body in a case where the position of the second moving body indicated by the second moving body information is within a predetermined distance range from the first region, a step of notifying a driver of the first moving body of a retreat command to retreat to another location in a case where the second moving body has stopped, a step of acquiring retreat completion information indicating that the first moving body has stopped at a retreat destination, and a step of, when the retreat completion information is acquired, setting a second region, where an unmanned vehicle is prohibited from entering, around the first moving body so as to be narrower than the first region.

A program according to the present disclosure causes a computer to execute a step of acquiring first moving body information including a position and a speed of a first moving body that is a manned vehicle, a step of setting a first region, where an unmanned vehicle is prohibited from entering, around the first moving body based on the first moving body information, a step of acquiring second moving body information including a position of a second moving body that is an unmanned vehicle, a step of stopping the second moving body in a case where the position of the second moving body indicated by the second moving body information is within a predetermined distance range from the first region, a step of notifying a driver of the first moving body of a retreat command to retreat to another location in a case where the second moving body has stopped, a step of acquiring retreat completion information indicating that the first moving body has stopped at a retreat destination, and a step of, when the retreat completion information is acquired, setting a second region, where an unmanned vehicle is prohibited from entering, around the first moving body so as to be narrower than the first region.

An information processing device according to the present disclosure includes a moving body information acquisition unit that acquires first moving body information including a position and a speed of a first moving body that is a manned vehicle and second moving body information including a position of a second moving body that is an unmanned vehicle, a region setting unit that sets a first region, where an unmanned vehicle is prohibited from entering, around the first moving body based on the first moving body information, a stop command unit that stops the second moving body in a case where the position of the second moving body indicated by the second moving body information is within a predetermined distance range from the first region, a retreat command unit that notifies a driver of the first moving body of a retreat command to retreat to another location in a case where the second moving body has stopped, and a retreat information acquisition unit that acquires retreat completion information indicating that the first moving body has stopped at a retreat destination, in which, when the retreat completion information is acquired, the region setting unit sets a second region, where an unmanned vehicle is prohibited from entering, around the first moving body so as to be narrower than the first region.

### Advantageous Effects of Invention

According to the present disclosure, it is possible to suppress or eliminate deadlock when the manned vehicle and the unmanned vehicle are moving.

### BRIEF DESCRIPTION OF DRAWINGS

FIG. 1 is a schematic diagram of a movement control system according to the present embodiment.

FIG. 2 is a schematic diagram of a configuration of a first moving body.

FIG. 3 is a schematic diagram of a configuration of a second moving body.

FIG. 4 is a schematic block diagram of a control device of the second moving body.

FIG. 5 is a schematic block diagram of a management device.

FIG. 6 is a schematic block diagram of an information processing device.

FIG. 7 is a schematic diagram showing an example of setting of a first region of the first moving body.

FIG. 8 is a schematic diagram showing an example of retreat of the first moving body.

FIG. 9 is a schematic diagram showing an example of setting of a third region.

FIG. 10 is a flowchart illustrating a processing flow of the movement control system.

### DESCRIPTION OF EMBODIMENTS

Hereinafter, a preferred embodiment of the present disclosure will be described in detail with reference to the accompanying drawings. The present disclosure is not limited to the embodiment. In addition, in a case where there are a plurality of embodiments, the present disclosure also includes a combination of the embodiments.

### (Movement Control System)

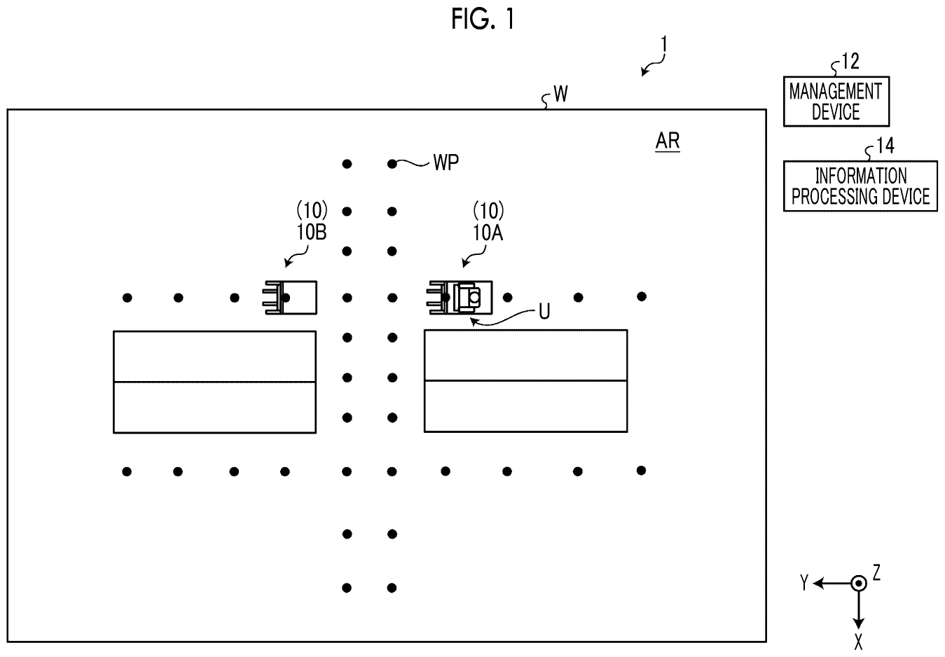

FIG. 1 is a schematic diagram of a movement control system according to the present embodiment. As shown in FIG. 1, a movement control system 1 according to the present embodiment includes a moving body 10, a management device 12, and an information processing device 14. The movement control system 1 is a system that controls a movement of the moving body 10 belonging to a facility W. The facility W is, for example, a facility that is involved in physical distribution management, such as a warehouse, but may be any facility that operates the moving body 10. In the movement control system 1, the moving body 10 picks up and transports an object disposed in a region AR of the facility W. The region AR is a region where the object is installed or the moving body 10 moves, and is, for example, a floor surface of the facility W. In the present embodiment, the object transported by the moving body 10 is a transport target with cargo loaded on a pallet. Note that the object is not limited to a transport target with cargo loaded on the pallet, and may be in any form. For example, the object may be only the cargo without the pallet. In addition, the moving body 10 is not limited to a moving body that transports the object, and may be a device that moves in the facility W for any purpose.

Hereinafter, one direction along the region AR is referred to as an X direction, and a direction along the region AR that intersects the direction X is referred to as a Y direction. In the present embodiment, the Y direction is a direction orthogonal to the X direction. The X direction and the Y direction may be referred to as directions along a horizontal plane. In addition, a direction orthogonal to the X direction and the Y direction, more specifically, a direction toward an upper side in a vertical direction, is referred to as a Z direction. In addition, in the present embodiment, the term “position” refers to a position (coordinates) in a coordinate system (coordinate system of the region AR) on a two-dimensional plane in the region AR, unless otherwise specified. In addition, the term “posture (orientation)” of the moving body 10 or the like refers to an orientation of the moving body 10 or the like in the coordinate system of the region AR, and indicates a yaw angle (rotation angle) of the moving body 10 when the X direction is set to 0° in a case where the moving body 10 or the like is viewed in the Z direction, unless otherwise specified.

### (Waypoint)

In the region AR, a waypoint WP is set for each position (coordinates). A route along which the moving body 10 moves is set to connect the waypoints WP. That is, a route connecting the waypoints WP through which the moving body 10 is planned to pass is a route of the moving body 10. The waypoint WP is set according to a layout of the facility W. For example, the waypoints WP are set in a matrix pattern in the region AR.

### (Moving Body)

In the present embodiment, the moving body 10 includes a first moving body 10A, which is a manned vehicle that moves in response to an operation of a driver, and a second moving body 10B, which moves autonomously.

### (First Moving Body)

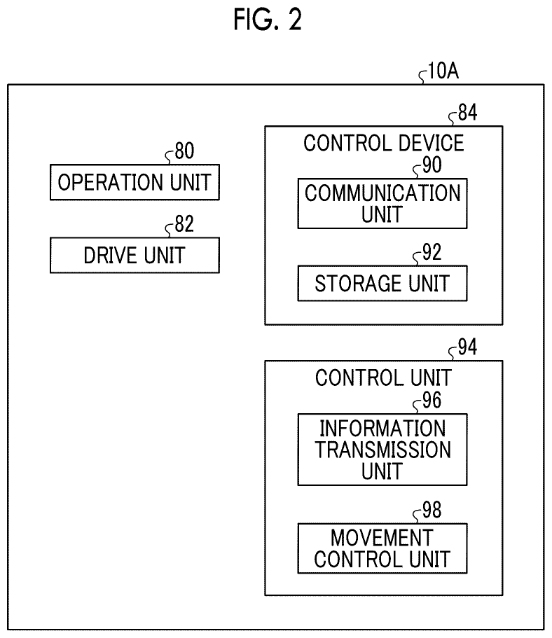

FIG. 2 is a schematic diagram of a configuration of a first moving body. The first moving body 10A as a manned vehicle is a device that moves in response to an operation of a driver U. For example, the first moving body 10A moves by being operated by the driver U aboard the first moving body 10A. Note that the present invention is not limited to this, and the first moving body 10A may move by being remotely operated by the driver U not aboard the first moving body 10A. In addition, in the present embodiment, the first moving body 10A is a device capable of transporting an object. Furthermore, in the present embodiment, the first moving body 10A is a forklift. Note that the first moving body 10A is not limited to a forklift that transports an object, and may be any device that can move in response to an operation of the driver U.

As shown in FIG. 2, the first moving body 10A includes an operation unit 80, a drive unit 82, and a control device 84. The operation unit 80 is an interface mechanism that receives an operation from the driver U, and may include, for example, a steering wheel, an accelerator, and a brake. The drive unit 82 is a drive mechanism that moves the first moving body 10A. The first moving body 10A moves when the drive unit 82 is driven by the operation of the driver U received by the operation unit 80.

The control device 84 is a device that controls the first moving body 10A. The control device 84 is a computer, and includes a communication unit 90, a storage unit 92, and a control unit 94. The communication unit 90 is a module used by the control unit 94 for communicating with an external device such as the information processing device 14, and may include, for example, an antenna. A communication method of the communication unit 90 is wireless communication in the present embodiment, but the communication method may be arbitrary. The storage unit 92 is a memory that stores various types of information such as calculation contents of the control unit 94 and programs, and includes, for example, at least one of a main storage device such as a random access memory (RAM) or a read only memory (ROM) and an external storage device such as a hard disk drive (HDD).

The control unit 94 is a calculation device, and includes, for example, a calculation circuit such as a central processing unit (CPU). The control unit 94 includes an information transmission unit 96 and a movement control unit 98. The control unit 94 reads out a program (software) from the storage unit 92 and executes the program (software), thereby realizing the information transmission unit 96 and the movement control unit 98, and executing processes thereof. The control unit 94 may execute the processes with one CPU or may include a plurality of CPUs and may execute the processes with the plurality of CPUs. In addition, at least a part of the information transmission unit 96 and the movement control unit 98 may be realized by a hardware circuit. In addition, a program for the control unit 94 stored in the storage unit 92 may be stored in a recording medium readable by the control device 84.

The information transmission unit 96 transmits first moving body information indicating a position and a speed of the first moving body 10A to an external device such as the information processing device 14, and the movement control unit 98 controls the movement of the first moving body 10A. Specific processing contents thereof will be described below. The movement control unit 98 automatically controls the first moving body 10A, for example, automatically stops the first moving body 10A. Note that, since the first moving body 10A is a manned vehicle, a function for automatically controlling the first moving body 10A is not required, in other words, the first moving body 10A does not need to include the movement control unit 98.

### (Second Moving Body)

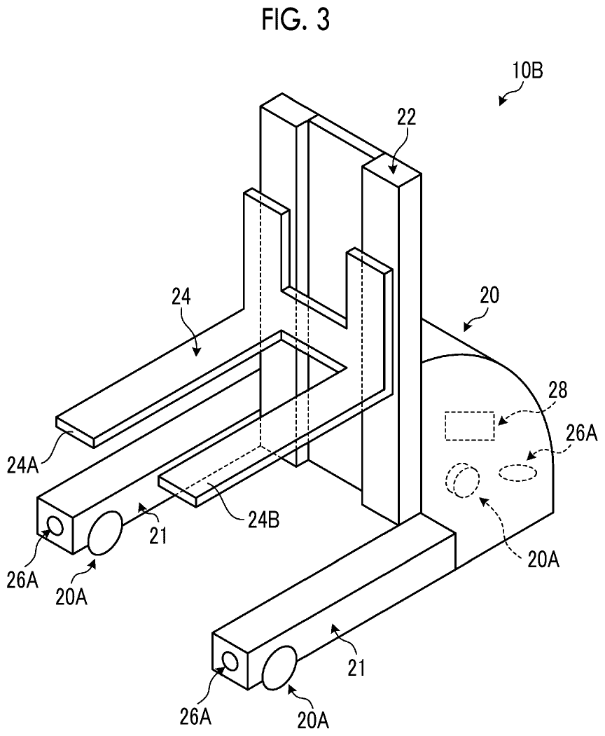

FIG. 3 is a schematic diagram of a configuration of a second moving body. The second moving body 10B as an unmanned vehicle is a device that can move automatically. In the present embodiment, the second moving body 10B is a device capable of transporting an object. Furthermore, in the present embodiment, the second moving body 10B is a forklift, more specifically, a so-called automated guided vehicle (AGV) or an automated guided forklift (AGF). Note that the second moving body 10B is not limited to a forklift that transports an object, and may be any device that can move automatically.

As shown in FIG. 3, the second moving body 10B includes a vehicle body 20, wheels 20A, straddle legs 21, a mast 22, a fork 24, a sensor 26A, and a control device 28. The straddle legs 21 are a pair of shaft-shaped members provided at one end portion of the vehicle body 20 in a front-rear direction and protruding from the vehicle body 20. The mast 22 is movably attached to the straddle legs 21 and moves in the front-rear direction of the vehicle body 20. The mast 22 extends along an up-down direction (here, the direction Z) orthogonal to the front-rear direction. The fork 24 is attached to the mast 22 to be movable in the direction Z. The fork 24 may also be movable relative to the mast 22 in a lateral direction (direction intersecting the up-down direction and the front-rear direction) of the vehicle body 20. The fork 24 has a pair of tines 24A and 24B. The tines 24A and 24B extend from the mast 22 toward a rear direction of the vehicle body 20. The tine 24A and the tine 24B are spaced apart from each other in the lateral direction of the mast 22. Hereinafter, in the front-rear direction, a direction on a side on which the fork 24 is not provided in the second moving body 10B is referred to as a front direction, and a direction on a side on which the fork 24 is provided is referred to as a rear direction.

The sensor 26A detects at least one of a position and a posture of an object present around the vehicle body 20. It can also be said that the sensor 26A detects at least one of the position of the object with respect to the second moving body 10B and the posture of the object with respect to the second moving body 10B. In the present embodiment, the sensors 26A are provided at a tip of each straddle leg 21 in the rear direction and on a front direction side of the vehicle body 20. Note that a position where the sensor 26A is provided is not limited to this, and the sensor 26A may be provided at any position, and the number of the sensors 26A provided may also be arbitrary.

The sensor 26A is, for example, a sensor that emits laser light. The sensor 26A emits laser light while performing scanning in one direction (here, the lateral direction) and detects the position and the orientation of the object from reflected light of the emitted laser light. That is, the sensor 26A can also be said to be a so-called two-dimensional (2D)-light detection and ranging (LiDAR). Note that the sensor 26A is not limited to the above and may be a sensor that detects the object using any method, for example, a so-called three-dimensional (3D)-LiDAR that performs scanning in a plurality of directions, a so-called one-dimensional (1D)-LiDAR that does not perform scanning, or a camera.

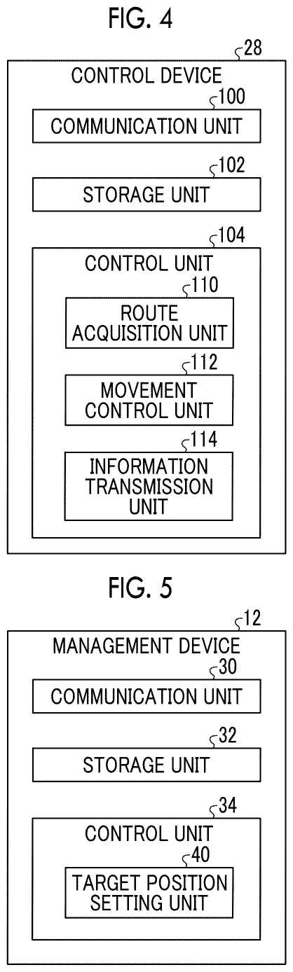

FIG. 4 is a schematic block diagram of a control device of the second moving body. The control device 28 is a device that controls the second moving body 10B. The control device 28 is a computer, and includes a communication unit 100, a storage unit 102, and a control unit 104 as shown in FIG. 4. The communication unit 100 is a module used by the control unit 104 for communicating with an external device such as the information processing device 14, and may include, for example, an antenna. A communication method of the communication unit 100 is wireless communication in the present embodiment, but the communication method may be arbitrary. The storage unit 102 is a memory that stores various kinds of information, such as calculation contents of the control unit 104 and programs, and includes, for example, at least one of a main storage device such as a RAM or a ROM and an external storage device such as an HDD.

The control unit 104 is a calculation device, and includes, for example, a calculation circuit such as a CPU. The control unit 104 includes a route acquisition unit 110, a movement control unit 112, and an information transmission unit 114. The control unit 104 reads out a program (software) from the storage unit 102 and executes the program (software), thereby realizing the route acquisition unit 110, the movement control unit 112, and the information transmission unit 114, and executing processes thereof. The control unit 104 may execute the processes with one CPU or may include a plurality of CPUs and may execute the processes with the plurality of CPUs. In addition, at least a part of the route acquisition unit 110, the movement control unit 112, and the information transmission unit 114 may be realized by a hardware circuit. In addition, a program for the control unit 104 stored in the storage unit 102 may be stored in a recording medium readable by the control device 28.

The route acquisition unit 110 acquires information on a route along which the second moving body 10B moves, the movement control unit 112 controls a movement mechanism such as a drive unit or steering of the second moving body 10B to control the movement of the second moving body 10B, and the information transmission unit 114 transmits second moving body information indicating a position of the second moving body 10B to an external device such as the information processing device 14. Specific processing contents thereof will be described below.

### (Management Device)

FIG. 5 is a schematic block diagram of a management device. The management device 12 is a system that manages physical distribution in the facility W. Although the management device 12 is a warehouse control system (WCS) or a warehouse management system (WMS) in the present embodiment, the management device 12 is not limited to the WCS and the WMS and may be any system, for example, a back-end system such as another production management system. A position where the management device 12 is provided is arbitrary, and the management device 12 may be provided in the facility W or may be provided at a location away from the facility W to manage the facility W from that location. The management device 12 is a computer, and as shown in FIG. 5, includes a communication unit 30, a storage unit 32, and a control unit 34.

The communication unit 30 is a module used by the control unit 34 for communicating with an external device such as the information processing device 14, and may include, for example, an antenna. A communication method of the communication unit 30 is wireless communication in the present embodiment, but the communication method may be arbitrary. The storage unit 32 is a memory that stores various kinds of information, such as calculation contents of the control unit 34 and programs, and includes, for example, at least one of a main storage device such as a RAM or a ROM and an external storage device such as an HDD.

The control unit 34 is a calculation device, and includes, for example, a calculation circuit such as a CPU. The control unit 34 includes a target position setting unit 40. The control unit 34 reads out a program (software) from the storage unit 32 and executes the program (software), thereby realizing the target position setting unit 40, and executing a process thereof. The control unit 34 may execute the process with one CPU or may include a plurality of CPUs and may execute the process with the plurality of CPUs. In addition, at least a part of the target position setting unit 40 may be realized by a hardware circuit. In addition, a program for the control unit 34 stored in the storage unit 32 may be stored in a recording medium readable by the management device 12.

The target position setting unit 40 sets a target position, which is a movement destination of the moving body 10. Specific processing contents of the target position setting unit 40 will be described below.

The management device 12 may also perform processes other than the setting of the target position. For example, the management device 12 may also set information for controlling a mechanism (for example, an elevator or a door) other than the moving body 10 provided in the facility W.

### (Information Processing Device)

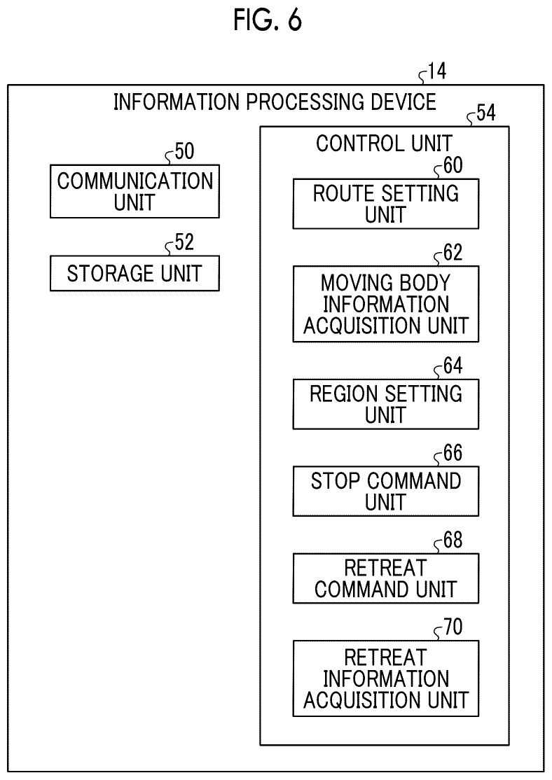

FIG. 6 is a schematic block diagram of an information processing device. The information processing device 14 is a device that processes information regarding the movement of the moving body 10. The information processing device 14 is, for example, a fleet control system (FCS), but is not limited to this, and may be any device that processes the information regarding the movement of the moving body 10. The information processing device 14 is a computer, and includes a communication unit 50, a storage unit 52, and a control unit 54 as shown in FIG. 6. The communication unit 50 is a module used by the control unit 54 for communicating with an external device such as the management device 12 and the moving body 10, and may include, for example, an antenna. A communication method of the communication unit 50 is wireless communication in the present embodiment, but the communication method may be arbitrary. The storage unit 52 is a memory that stores various kinds of information, such as calculation contents of the control unit 54 and programs, and includes, for example, at least one of a main storage device such as a RAM or a ROM and an external storage device such as an HDD.

The control unit 54 is a calculation device, and includes, for example, a calculation circuit such as a CPU. The control unit 54 includes a route setting unit 60, a moving body information acquisition unit 62, a region setting unit 64, a stop command unit 66, a retreat command unit 68, and a retreat information acquisition unit 70. The control unit 54 reads out a program (software) from the storage unit 52 and executes the program (software), thereby realizing the route setting unit 60, the moving body information acquisition unit 62, the region setting unit 64, the stop command unit 66, the retreat command unit 68, and the retreat information acquisition unit 70, and executing processes thereof. The control unit 54 may execute the processes with one CPU or may include a plurality of CPUs and may execute the processes with the plurality of CPUs. In addition, at least a part of the route setting unit 60, the moving body information acquisition unit 62, the region setting unit 64, the stop command unit 66, the retreat command unit 68, and the retreat information acquisition unit 70 may be realized by a hardware circuit. In addition, a program for the control unit 54 stored in the storage unit 52 may be stored in a recording medium readable by the information processing device 14.

The route setting unit 60 sets a route of the second moving body 10B as an unmanned vehicle, and the moving body information acquisition unit 62 acquires information on the moving body 10. The region setting unit 64 sets a protection region (a first region AR1, a second region AR2, and a third region AR3 to be described below) where the second moving body 10B is prohibited from entering, for the first moving body 10A. The stop command unit 66 outputs a stop command for stopping the second moving body 10B, the retreat command unit 68 outputs a retreat command to retreat the first moving body 10A to another location, and the retreat information acquisition unit 70 acquires retreat completion information indicating that the first moving body 10A has stopped at a retreat destination. Specific processing contents thereof will be described below.

In the present embodiment, the management device 12 and the information processing device 14 are separate devices, but may be integrated into one device. That is, the management device 12 may have at least some functions of the information processing device 14, and the information processing device 14 may have some functions of the management device 12.

### (Processing of Movement Control System)

Processing contents of the movement control system 1 will be described below.

### (Setting of Target Position)

The target position setting unit 40 of the management device 12 sets a target position, which is a movement destination of the second moving body 10B that is an unmanned vehicle. The target position setting unit 40 may set any position in the facility W as the target position. For example, a waypoint WP to which the second moving body 10B is to move may be set based on preset order information indicating an object to be transported and a transport origin and a transport destination of the object, and the waypoint WP may be set as the target position. The target position setting unit 40 may set a target position for the first moving body 10A, which is a manned vehicle, in the same manner as the second moving body 10B described above.

The management device 12 transmits position information of the set target position to the information processing device 14. That is, it can be said that the information processing device 14 acquires the position information of the target position set by the target position setting unit 40 of the management device 12. The position information of the target position may be any information indicating the position of the target position, for example, information indicating coordinates of the target position or information indicating an identifier of the waypoint WP corresponding to the target position.

### (Setting of Route of Second Moving Body)

The route setting unit 60 of the information processing device 14 sets a route toward the target position as a route of the second moving body 10B, which is an unmanned vehicle, based on the position information of the target position. In the present embodiment, the route setting unit 60 sets a route connecting each waypoint WP from a movement origin of the second moving body 10B to the target position as the route of the second moving body 10B. The position of the movement origin may be set as desired, and, for example, a waypoint WP closest to a position where the second moving body 10B starts movement may be set as the movement origin.

The information processing device 14 transmits the information on the route to the second moving body 10B, and the route acquisition unit 110 of the second moving body 10B acquires the information on the route set by the information processing device 14. The information on the route may be any information indicating the position of the route, but, in the present embodiment, it may be position information of the waypoint WP included in the route.

The route setting unit 60 of the information processing device 14 sets a region overlapping a route set for the second moving body 10B, as an occupied region. The occupied region refers to a region in which the second moving body 10B for which the occupied region is set is permitted to enter, but other unmanned vehicles are not permitted to enter. In the present embodiment, the route setting unit 60 sets the waypoints WP included in the route set for the second moving body 10B as the occupied region in a planned time period during which the second moving body 10B is planned to move along the route. This prevents the waypoints WP included in the occupied region from being overlappingly reserved as a route through which other unmanned vehicles pass in the planned time period, thereby making it possible to suppress interference and deadlock between unmanned vehicles.

In this way, in the present embodiment, the information processing device 14 sets the route of the second moving body 10B, but the entity that sets the route is not limited to the information processing device 14 and may be any entity. For example, the route acquisition unit 110 of the second moving body 10B may set the route in the same manner as described above.

### (Movement of Second Moving Body)

The second moving body 10B, which is an unmanned vehicle, moves along the set route. That is, the movement control unit 112 of the second moving body 10B moves the second moving body 10B according to the route acquired by the route acquisition unit 110. More specifically, in the present embodiment, it is preferable that the route acquisition unit 110 sets a second route (global path) based on a first route (layout path) which is the route acquired from the information processing device 14. In this case, the route acquisition unit 110 sets the second route based on the first route and vehicle specification information of the second moving body 10B. The vehicle specification information is, for example, a specification that affects a route along which the second moving body 10B can move, such as the size or the minimum turning radius of the second moving body 10B. The second route is also a route toward the target position, as with the first route. Furthermore, the second route is a route that can be followed by the second moving body 10B and that leads to the target position.

The movement control unit 112 sequentially obtains the position information of the second moving body 10B to move the second moving body 10B to pass through the set route (second route in the example of the present embodiment). The method for acquiring the position information of the second moving body 10B is arbitrary, but, for example, in the present embodiment, a detection body (not shown) is provided in the facility W, and the movement control unit 112 acquires the information of the position and the posture of the second moving body 10B based on detection of the detection body. Specifically, the second moving body 10B emits laser light toward the detection body and receives reflected light of the laser light from the detection body to detect the position and the posture of the second moving body 10B in the facility W. The method for acquiring the information of the position and the posture of the second moving body 10B is not limited to the method using the detection body, and, for example, simultaneous localization and mapping (SLAM) may be used.

The second moving body 10B acquires second moving body information via the movement control unit 112. The second moving body information is information including the position of the second moving body 10B, and is preferably information including the position, the posture (orientation), and the speed of the second moving body 10B. The movement control unit 112 sequentially acquires the second moving body information. In the present embodiment, the movement control unit 112 sequentially acquires the second moving body information while the second moving body 10B is moving along the set route (in this example, the second route). The method for acquiring the second moving body information may be arbitrary, but, for example, the position and the orientation may be acquired using a detection body or SLAM, as described above, and the speed may be detected by a speed sensor provided on the second moving body 10B.

The information transmission unit 114 of the second moving body 10B transmits the second moving body information to the information processing device 14. That is, the moving body information acquisition unit 62 of the information processing device 14 sequentially acquires the second moving body information from the second moving body 10B.

### (Movement of First Moving Body)

The first moving body 10A, which is a manned vehicle, moves in response to an operation of the driver U. The first moving body 10A moves along a route according to the operation of the driver U. For example, the driver U may ascertain the information on the target position of the first moving body 10A set by the management device 12 or the information processing device 14 and move the first moving body 10A toward the target position. In the present embodiment, the route of the first moving body 10A does not have to be set in advance by the information processing device 14.

### (Setting of First Region)

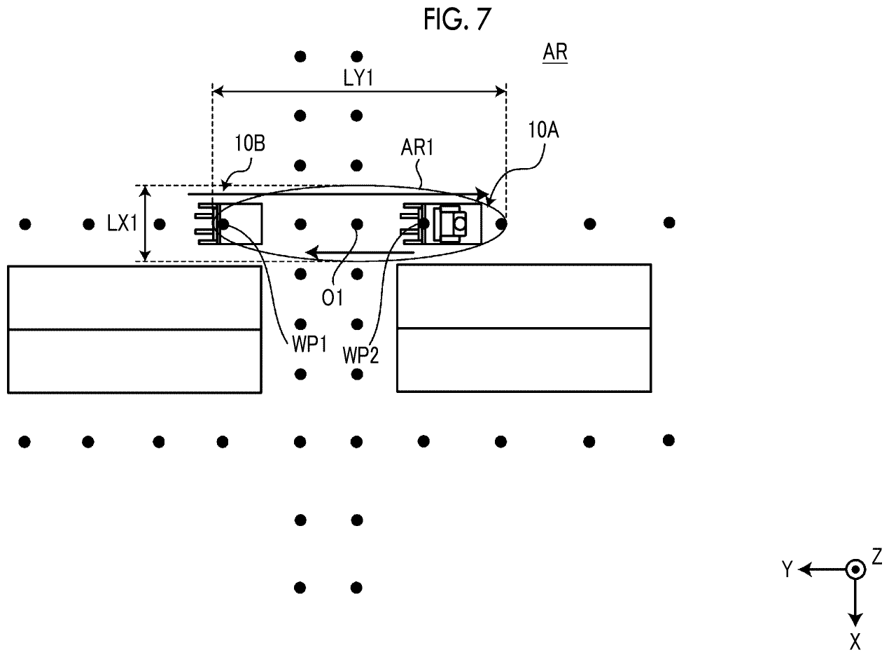

FIG. 7 is a schematic diagram showing an example of setting of a first region of the first moving body. The first moving body 10A acquires first moving body information via the information transmission unit 96. The first moving body information is information including the position and the speed of the first moving body 10A, and is preferably information including the position, the posture (orientation), and the speed of the first moving body 10A. The information transmission unit 96 sequentially acquires the first moving body information. In the present embodiment, the information transmission unit 96 sequentially acquires the first moving body information while the first moving body 10A is moving in response to the operation of the driver U. The method for acquiring the first moving body information may be arbitrary, but, for example, the position and the orientation may be acquired using a detection body or SLAM, as in the second moving body 10B, and the speed may be detected by a speed sensor provided on the first moving body 10A.

The information transmission unit 96 of the first moving body 10A transmits the first moving body information to the information processing device 14. That is, the moving body information acquisition unit 62 of the information processing device 14 acquires the first moving body information from the first moving body 10A.

The region setting unit 64 of the information processing device 14 sets the first region AR1 around the first moving body 10A based on the first moving body information. The first region AR1 is a region set around the first moving body 10A, and is a region where an unmanned vehicle is prohibited from entering. Based on the first moving body information, the region setting unit 64 sets a region including a position that the first moving body 10A is likely to reach before stopping, in a case where it is assumed that the first moving body 10A starts deceleration from its current position (position indicated by the first moving body information), as the first region AR1. It is preferable that the region setting unit 64 sets the first region AR1 based on the vehicle specification information of the first moving body 10A (size, performance, and the like of the first moving body 10A) in addition to the first moving body information.

The method for setting the first region AR1 may be arbitrary, but, in the present embodiment, the region setting unit 64 calculates a first length LY1, a second length LX1, and a position O1 based on the first moving body information and the vehicle specification information, and sets, as the first region AR1, an elliptical region centered on the position O1, with the first length LY1 as a major axis and the second length LX1 as a minor axis. The position O1 is a position where it is assumed that the first moving body 10A starts deceleration. In addition, the first length LY1 is a distance in a traveling direction of the first moving body 10A, in which the first moving body 10A may move from when it starts deceleration until it stops. In addition, the second length LX1 is a distance in a direction orthogonal to the traveling direction of the first moving body 10A, in which the first moving body 10A may move until it stops. For example, the region setting unit 64 calculates a distance LO1 from the current position of the first moving body 10A to the position O1 based on the following equation (1), calculates the first length LY1 based on the following equation (2), and calculates the second length LX1 based on the following equation (3). The position O1 is a position separated by the distance LO1 from the current position of the first moving body 10A to the traveling direction side of the first moving body 10A.

$$LO 1 = {v}_{s} \cdot {t}_{d} + {v}_{s}^{2} / ( 2 \cdot {D}_{max} ) \qquad ( 1 )$$

$$LY 1 = {L}_{1} + LO 1 + {L}_{o m} + 2 \cdot E \qquad ( 2 )$$

$$LX 1 = 4 \cdot {L}_{v} + 2 \cdot E + {L}_{v m} \qquad ( 3 )$$

vₛ in Equation (1) is a value represented by the following equation (4), and is a value taking into account that the driver U accelerates until the driver U applies the brake.

$${v}_{s} = min ( {V}_{max} , {v}_{t} + {A}_{max} ( {t}_{d} + {t}_{w} ) ) \qquad ( 4 )$$

Here, vₜ is the speed of the first moving body 10A indicated by the first moving body information, vₘₐₓ is the maximum speed of the first moving body 10A, Aₘₐₓ is the maximum acceleration of the first moving body 10A, Dₘₐₓ is the maximum deceleration of the first moving body 10A, ta is a delay until the driver V issues a deceleration command, t_{w} is a delay from when the deceleration command is received until the first moving body 10A starts to mechanically decelerate from acceleration, Lᵥ is a half value of the width of the first moving body 10A (length in a direction orthogonal to the traveling direction), L₁ is the length of the first moving body 10A (length in the traveling direction), E is a recognition error, Lₒₘ is an ellipse approximation value in the traveling direction, and Lᵥₘ is an ellipse approximation value in the direction orthogonal to the traveling direction. The values of Vₘₐₓ, Aₘₐₓ, Dₘₐₓ, t_{d}, t_{w}, Lᵥ, L₁, and E are set in advance as the vehicle specification information.

The information processing device 14 sequentially acquires the first moving body information, and sets (updates) the first region AR1 of the first moving body 10A every time the first moving body information is acquired. The entity that sets the first region AR1 of the first moving body 10A is not limited to the information processing device 14. For example, the first moving body 10A itself may set the first region AR1. In addition, the entity that sets the second region AR2 and the third region AR3 to be described below is not limited to the information processing device 14 and may be any entity, and for example, the first moving body 10A may set them.

### (Determination of Stop of Second Moving Body)

As described above, in the present embodiment, the first moving body 10A moves while the first region AR1 is updated, and the second moving body 10B moves along the set route. The stop command unit 66 of the information processing device 14 determines whether to stop the movement of the second moving body 10B, based on the position information of the first region AR1 of the first moving body 10A and the second moving body information of the second moving body 10B, in order to suppress the interference between the first moving body 10A and the second moving body 10B. The stop command unit 66 determines to stop the second moving body 10B in a case where the current position (position indicated by the second moving body information) of the second moving body 10B is within a predetermined distance range from the first region AR1 of the first moving body 10A (preferably, in a case where the current position of the second moving body 10B is within the first region AR1). On the other hand, the stop command unit 66 determines not to stop the second moving body 10B in a case where the current position of the second moving body 10B is not within a predetermined distance range from the first region AR1 of the first moving body 10A (preferably, in a case where the current position of the second moving body 10B is outside the first region AR1).

In a case where it is determined that the second moving body 10B is to be stopped, the stop command unit 66 transmits a stop command indicating that the second moving body 10B is to be stopped, to the second moving body 10B. When receiving the stop command, the movement control unit 112 of the second moving body 10B stops the second moving body 10B. In a case where the stop command unit 66 determines that the second moving body 10B is not to be stopped, the stop command unit 66 does not transmit the stop command and does not stop the second moving body 10B.

### (Deadlock Between First Moving Body and Second Moving Body)

Here, in a case where the second moving body 10B is located on the traveling direction side of the first moving body 10A, the driver U of the first moving body 10A may stop the first moving body 10A not to interfere with the second moving body 10B. On the other hand, in a case where the second moving body 10B approaches the first region AR1 of the first moving body 10A as described above, the second moving body 10B stops so as not to interfere with the first moving body 10A. Therefore, for example, in a case where the second moving body 10B is located on the traveling direction side of the first moving body 10A and the first moving body 10A is located on the traveling direction side of the second moving body 10B, deadlock may occur in which the first moving body 10A and the second moving body 10B remain stopped and are unable to move. In the example of FIG. 7, the second moving body 10B is located at a waypoint WP1 and is moving toward a waypoint WP2, and the first moving body 10A is located at the waypoint WP2 and is moving toward the waypoint WP1. As a result, since the waypoint WP1 is within the first region AR1 of the first moving body 10A, the second moving body 10B is stopped. In this case, the driver U of the first moving body 10A is unable to head toward the waypoint WP1 because the second moving body 10B is in the way, so the driver U of the first moving body 10A has to stop the first moving body 10A at the current position until the second moving body 10B moves. Meanwhile, the second moving body 10B also stops at the current position until the first moving body 10A moves, so that deadlock occurs. In addition, in other cases as well, deadlock may occur between the first moving body 10A and the second moving body 10B.

On the other hand, in the present embodiment, when the second moving body 10B is stopped, the driver U of the first moving body 10A is notified of the retreat command, and the driver U of the first moving body 10A is prompted to move to another location. As a result, the first moving body 10A moves away from the second moving body 10B and the second moving body 10B can resume the movement, so that it is possible to eliminate the deadlock that has occurred or to suppress the occurrence of the deadlock. Hereinafter, specific processing will be described.

### (Notification of Retreat Command)

When the second moving body 10B is stopped after the stop command is transmitted, the retreat command unit 68 of the information processing device 14 notifies the driver U of the first moving body 10A of the retreat command. The retreat command is a command to retreat the first moving body 10A to another location. The trigger for determining whether to notify of the retreat command may be arbitrary. For example, the retreat command unit 68 may determine to output the retreat command in a case where the second moving body information received from the second moving body 10B indicates that the second moving body 10B is stopped (for example, in a case where the speed is zero) after the stop command is transmitted to the second moving body 10B. In addition, for example, the retreat command unit 68 may determine to output the retreat command in a case where the second moving body 10B is stopped due to the deadlock. The criteria for determining whether the deadlock has occurred may be arbitrary, but, for example, the retreat command unit 68 may determine that the deadlock has occurred and output the retreat command in a case where the second moving body 10B has stopped for a predetermined time or longer after transmitting the stop command (for example, in a case where a state in which the second moving body information indicates that it is stopped continues for a predetermined time or longer).

The retreat command unit 68 may notify the driver U of the retreat command using any method. For example, the retreat command unit 68 may transmit the retreat command to a terminal carried by the driver U or to the first moving body 10A, and may cause the terminal or the first moving body 10A to output the retreat command. The method for outputting the retreat command here may be arbitrary, and, for example, an image or voice indicating the retreat command may be output. That is, for example, an image indicating the retreat command may be displayed on a display mounted on the terminal carried by the driver U or the first moving body 10A, or a voice indicating the retreat command may be output to a speaker mounted on the terminal carried by the driver U or to the first moving body 10A. In addition, for example, the retreat command may be output to a display or a speaker provided in the facility W.

### (Setting of Retreat Position)

The retreat command unit 68 may set a retreat position which is the retreat destination of the first moving body 10A. Although the retreat command unit 68 may set any position as the retreat position, it is preferable that the retreat position is set based on the current position and the movement destination of the second moving body, more specifically, based on the current position of the second moving body 10B and the route of the second moving body 10B. It is preferable that the retreat command unit 68 sets a position away from a section from the current position of the second moving body 10B to the movement destination (target position) in the route of the second moving body 10B, as the retreat position.

In addition, for example, the retreat command unit 68 may set the retreat position based on at least one of the first moving body information and the movement destination of the first moving body 10A. In this case, for example, the retreat command unit 68 may calculate a position within a predetermined distance range from the current position (preferably, the closest position) of the first moving body 10A among positions away from the section from the current position of the second moving body 10B to the movement destination (target position) based on the first moving body information, and set the position as the retreat destination. In addition, for example, the retreat command unit 68 may calculate a position that overlaps a route connecting the current position and the movement destination of the first moving body 10A among the positions away from the section from the current position of the second moving body 10B to the movement destination (target position) based on the current position and the movement destination of the first moving body 10A, and may set the position as the retreat destination. The information on the movement destination of the first moving body 10A may be acquired as desired. For example, the information on the movement destination input to the second moving body 10B by the driver U of the first moving body 10A may be transmitted, or, for example, the movement destination indicated by the work content of the first moving body 10A may be acquired.

The retreat command unit 68 notifies the driver U of the first moving body 10A of the information on the retreat position set in this way, together with the retreat command. The method for notifying of the retreat position may be arbitrary. For example, an image or voice indicating the retreat position may be output to the display or the speaker mounted on the terminal carried by the driver U or to the first moving body 10A. In addition, for example, the first moving body 10A may be provided with a light source that emits light to a road surface on the traveling direction side, and the light source may emit light indicating the retreat position. In this case, for example, the light source may emit light in an arrow shape indicating a direction to the retreat position. In addition, for example, a light source (lamp) is provided at each position of the facility W, and the retreat position may be notified of by lighting the light source disposed in the vicinity of the retreat position. In addition, for example, the driver U may wear a head mount display (HMD), and the HMD may display an augumented reality (AR) image (for example, an arrow indicating the direction to the retreat position) indicating the retreat position on the road surface in a superimposed manner.

The trigger for setting the retreat position may be arbitrary. For example, when it is determined that the retreat command is to be notified of, it may be determined that the retreat position is to be set. In addition, for example, in a case where a request to indicate the retreat position is received from the driver U of the first moving body 10A after the retreat command is notified of, it may be determined that the retreat position is to be set. The request to indicate the retreat position may be received by any method, and, for example, the request input to the terminal carried by the driver U or to the first moving body 10A may be received. Note that the setting of the retreat position is not essential, and the driver U may move the first moving body 10A toward the retreat destination selected by the driver U himself/herself without setting the retreat position.

### (Acquisition of Retreat Completion Information)

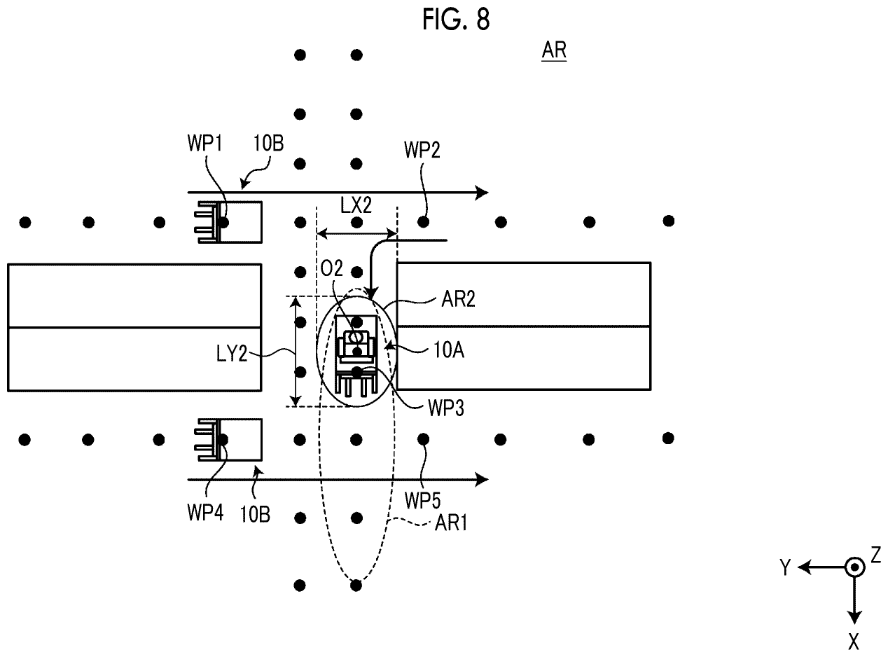

FIG. 8 is a schematic diagram showing an example of retreat of the first moving body. When the retreat command is notified of, the driver U of the first moving body 10A moves the first moving body 10A from the current position to the retreat destination (in this example, the set retreat position). When the driver U moves the first moving body 10A to the retreat destination, the driver U stops the first moving body 10A at the retreat destination. Then, the driver U notifies the information processing device 14 of the retreat completion information indicating that the first moving body 10A has stopped at the retreat destination. In this manner, the retreat information acquisition unit 70 of the information processing device 14 acquires the retreat completion information.

The method for acquiring the retreat completion information may be arbitrary. For example, when the retreat command is received, the display mounted on the terminal carried by the driver U or the first moving body 10A may display an image for inputting that the retreat has been completed. In this case, when the retreat is completed and the first moving body 10A is stopped, the driver U may input that the retreat has been completed on the display (touch panel) on which the image is displayed, and the terminal or the first moving body 10A may transmit the retreat completion information to the information processing device 14. For example, a sensor (for example, a pressure sensor) may be provided on a steering wheel of the first moving body 10A to detect whether the driver U is holding the steering wheel, and, when the sensor detects that the driver U is not holding the steering wheel, the first moving body 10A may transmit the retreat completion information to the information processing device 14. In addition, for example, a sensor (for example, a pressure sensor provided in a seat of the driver U or the like) may be provided at a location where the driver U of the first moving body 10A is on board to detect whether the driver U is on board, and, when the sensor detects that the driver U is not on board, the first moving body 10A may transmit the retreat completion information to the information processing device 14. In addition, for example, the driver U may turn off the power supply of the first moving body 10A as a trigger. In this case, for example, the information processing device 14 may acquire information indicating that the power supply of the first moving body 10A is turned off and the first moving body 10A is in the retreat position in the immediately preceding first moving body information, as the retreat completion information. In addition, for example, the information processing device 14 may acquire information indicating that the first moving body 10A is in the retreat position in the first moving body information, as the retreat completion information. In this case, the information processing device 14 may output a command to stop the first moving body 10A to the movement control unit 98, causing the first moving body 10A to automatically stop, so that the first moving body 10A is brought into a state where it cannot be started even by the operation of the driver U.

When the retreat completion information is acquired, the stop command unit 66 of the information processing device 14 transmits a stop release command to release the stop of the second moving body 10B to the second moving body 10B. When the stop release command is received, the movement control unit 112 of the second moving body 10B resumes the movement of the second moving body 10B. As a result, the second moving body 10B can move to the target position without being hindered by the first moving body 10A. In the example of FIG. 8, the first moving body 10A is stopped at a waypoint WP3 which is the retreat destination, and the retreat completion information is acquired. Therefore, the second moving body 10B receives the stop release command and resumes the movement from the waypoint WP1 to the waypoint WP2. The trigger for transmitting the stop release command, that is, the trigger for resuming the movement of the second moving body 10B is not limited to the acquisition of the retreat completion information (the first moving body 10A has stopped at the movement destination). For example, in a case where the current position of the second moving body 10B is outside a predetermined distance range from the first region AR1 of the first moving body 10A after the stop command is output (for example, in a case where the current position of the second moving body 10B is outside the first region AR1), the stop command unit 66 may transmit the stop release command to the second moving body 10B.

### (Setting of Second Region)

When the retreat completion information is acquired, the region setting unit 64 of the information processing device 14 sets the second region AR2 of the first moving body 10A. The second region AR2 is a region set around the first moving body 10A (that is, around the retreat destination), and is a region where an unmanned vehicle is prohibited from entering. That is, when the retreat completion information is acquired, the region setting unit 64 switches the protection region where an unmanned vehicle is prohibited from entering, from the first region AR1 to the second region AR2. Therefore, as in the first region AR1, the stop command unit 66 stops the second moving body 10B in a case where the current position (position indicated by the second moving body information) of the second moving body 10B, which is an unmanned vehicle, is within a predetermined distance range from the second region AR2 (preferably, in a case where the current position of the second moving body 10B is within the second region AR2), and does not stop the second moving body 10B in a case where the current position of the second moving body 10B is not within a predetermined distance range from the second region AR2 (preferably, in a case where the current position of the second moving body 10B is outside the second region AR2).

The region setting unit 64 sets the second region AR2 such that an area of the second region AR2 is smaller than an area of the first region AR1. It is preferable that the region setting unit 64 sets the second region AR2 to have an area smaller than the area of the first region AR1 and an area equal to or larger than the size of the first moving body 10A, based on the vehicle specification information of the first moving body 10A. More specifically, it is preferable that the region setting unit 64 sets the second region AR2 such that a length of the second region AR2 in the traveling direction of the first moving body 10A is shorter than a length of the first region AR1 in the traveling direction of the first moving body 10A.

The method for setting the second region AR2 may be arbitrary, but, in the present embodiment, the region setting unit 64 calculates a first length LY2, a second length LX2, and a position O2 based on the position information of the retreat destination of the first moving body 10A (the current position of the first moving body 10A) and the vehicle specification information, and sets, as the second region AR2, an elliptical region centered on the position O2, with the first length LY2 as a major axis and the second length LX2 as a minor axis. The position O2 is a position corresponding to the retreat destination of the first moving body 10A (for example, a position of the retreat destination). In addition, the first length LY2 is a length corresponding to a length of the first moving body 10A in the traveling direction. In addition, the second length LX2 is a length corresponding to a width of the first moving body 10A. For example, the region setting unit 64 calculates the first length LY2 based on the following equation (5) and calculates the second length LX2 based on the following equation (6). The position O2 may be the retreat destination (the current position of the first moving body 10A) of the first moving body 10A.

$$LY 2 = {L}_{1} + 2 \cdot E \qquad ( 5 )$$

$$LX 2 = 4 \cdot {L}_{v} + 2 \cdot E \qquad ( 6 )$$

In this way, when the retreat completion information is acquired, that is, when it is confirmed that the first moving body 10A has stopped at the retreat destination, the region setting unit 64 reduces the protection region where an unmanned vehicle is prohibited from entering, from the first region AR1 to the second region AR2. As a result, it is possible to suppress the hindrance to the movement of another unmanned vehicle due to the movement of the first moving body 10A to the retreat destination. That is, in the example of FIG. 8, another second moving body 10B (unmanned vehicle) is about to move from a waypoint WP4 toward a waypoint WP5. In this case, for example, when the protection region of the first moving body 10A that has stopped at the waypoint WP3, which is the retreat destination, remains the first region AR1, a section between the waypoint WP4 and the waypoint WP5 is located within the first region AR1, and the second moving body 10B stops. On the other hand, the protection region of the first moving body 10A that has stopped at the waypoint WP3 is reduced to the second region AR2, so that the section between the waypoint WP4 and the waypoint WP5 does not overlap the second region AR2, and the second moving body 10B can continue moving.

In addition, after the second region AR2 is set, in a case where the first movement information of the first moving body 10A indicates that the first moving body 10A is moving (for example, in a case where the speed is greater than zero), the region setting unit 64 sets the first region AR1 and returns the protection region from the second region AR2 to the first region AR1.

### (Setting of Third Region)

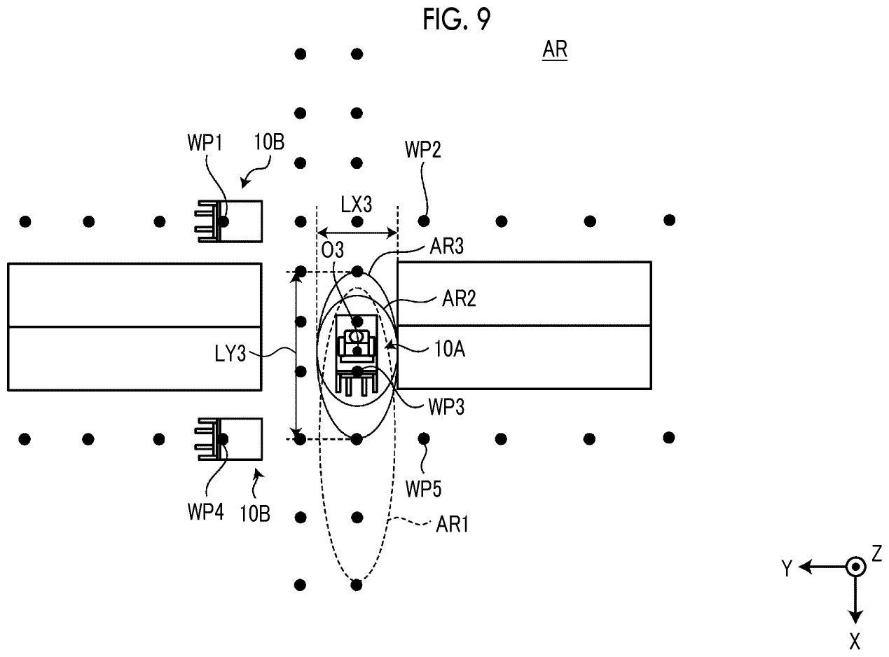

It is preferable that the region setting unit 64 of the information processing device 14 also sets the third region AR3 as the protection region. FIG. 9 is a schematic diagram showing an example of setting of a third region. The region setting unit 64 sets the third region AR3 in a case where the first moving body information indicates that the first moving body 10A is stopped (for example, in a case where the speed of the first moving body 10A is zero) after the retreat command is notified of and before the retreat completion information is acquired. Furthermore, the region setting unit 64 switches the protection region where an unmanned vehicle is prohibited from entering, from the first region AR1 to the third region AR3, after the retreat command is output and in a case where the first moving body 10A is stopped at the retreat destination (for example, in a case where the position indicated by the first moving body information is the retreat destination and the speed is zero). Therefore, as in the first region AR1, the stop command unit 66 stops the second moving body 10B in a case where the current position of the second moving body 10B, which is an unmanned vehicle, is within a predetermined distance range from the third region AR3 (preferably, in a case where the current position of the second moving body 10B is within the third region AR3), and does not stop the second moving body 10B in a case where the current position of the second moving body 10B is not within a predetermined distance range from the third region AR3 (preferably, in a case where the current position of the second moving body 10B is outside the third region AR3).

The region setting unit 64 sets the third region AR3 such that an area of the third region AR3 is smaller than the area of the first region AR1 and larger than the area of the second region AR2. It is preferable that the region setting unit 64 sets the third region AR3 to have an area smaller than the area of the first region AR1 and larger than the area of the second region AR2, based on the vehicle specification information of the first moving body 10A. More specifically, it is preferable that the region setting unit 64 sets the third region AR3 such that a length of the third region AR3 in the traveling direction of the first moving body 10A is shorter than a length of the first region AR1 in the traveling direction of the first moving body 10A and longer than a length of the second region AR2 in the traveling direction of the first moving body 10A. In addition, it is preferable that the region setting unit 64 sets the third region AR3 such that a length of the third region AR3 in a direction opposite to the traveling direction of the first moving body 10A is longer than a length of the first region AR1 in the direction opposite to the traveling direction and longer than a length of the second region AR2 in the direction opposite to the traveling direction. In this way, by increasing the length of the third region AR3 in the direction opposite to the traveling direction, even in a case where the first moving body 10A makes a sudden start in the opposite direction, it is possible to suppress interference with another moving body 10.

The method for setting the third region AR3 may be arbitrary, but, in the present embodiment, the region setting unit 64 calculates a first length LY3, a second length LX3, and a position O3 based on the first moving body information and the vehicle specification information, and sets, as the third region AR3, an elliptical region centered on the position O3, with the first length LY3 as a major axis and the second length LX3 as a minor axis. The position O3 is a position corresponding to the current position of the first moving body 10A, and the first length LY3 is a distance in the traveling direction of the first moving body 10A, in which the first moving body 10A may move from when it resumes movement until it stops. In addition, the second length LX3 is a distance in the direction orthogonal to the traveling direction of the first moving body 10A, in which the first moving body 10A may move from when it resumes movement until it stops. For example, the region setting unit 64 calculates a distance LO3 from the current position of the first moving body 10A to the position O3 based on the following equation (7), calculates the first length LY3 based on the following equation (8), and calculates the second length LX3 based on the following equation (9). The position O3 is a position separated by the distance LO3 from the current position of the first moving body 10A to the traveling direction side of the first moving body 10A.

$$LO 3 = {v}_{s} \cdot {t}_{d} + {v}_{s}^{2} / ( 2 \cdot {D}_{max} ) \qquad ( 7 )$$

$$LY 3 = {L}_{1} + 2 \cdot LO 3 + {L}_{o m} + 2 \cdot E \qquad ( 8 )$$

$$LX 3 = 4 \cdot {L}_{v} + 2 \cdot E + {L}_{v m} \qquad ( 9 )$$

vₛ in Equation (7) is a value represented by the following equation (10), and is a value taking into account that the driver U accelerates. Note that vₜ in Equation (10) is zero.

$${v}_{s} = min ( {V}_{max} , {v}_{t} + {A}_{max} ( {t}_{d} + {t}_{w} ) ) \qquad ( 10 )$$

Although the first moving body 10A is stopped, the first moving body 10A may resume movement before the retreat completion information is acquired, that is, in a state where the driver U has not confirmed that the first moving body 10A has stopped. In such a case, if the protection region is set to the second region AR2, the first moving body 10A may resume movement and interfere with an unmanned vehicle approaching the second region AR2. On the other hand, in such a case, by setting the third region AR3 wider than the second region AR2, the interference with the unmanned vehicle can be suppressed. Furthermore, by making the third region AR3 narrower than the first region AR1, it is possible to prevent the protection region from being too wide and also to suppress the hindrance to the movement of the unmanned vehicle. That is, by setting the third region AR3 in this manner, it is possible to suppress the interference with another unmanned vehicle without hindering the movement of the other unmanned vehicle as much as possible.

Furthermore, after switching to the third region AR3, when the retreat completion information is acquired, the region setting unit 64 sets the second region AR2 and switches the protection region where an unmanned vehicle is prohibited from entering, from the third region AR3 to the second region AR2. On the other hand, after switching to the third region AR3, in a case where the first movement information of the first moving body 10A indicates that the first moving body 10A is moving (for example, in a case where the speed is greater than zero), the region setting unit 64 sets the first region AR1 and returns the protection region from the third region AR3 to the first region AR1.

### (Processing Flow)

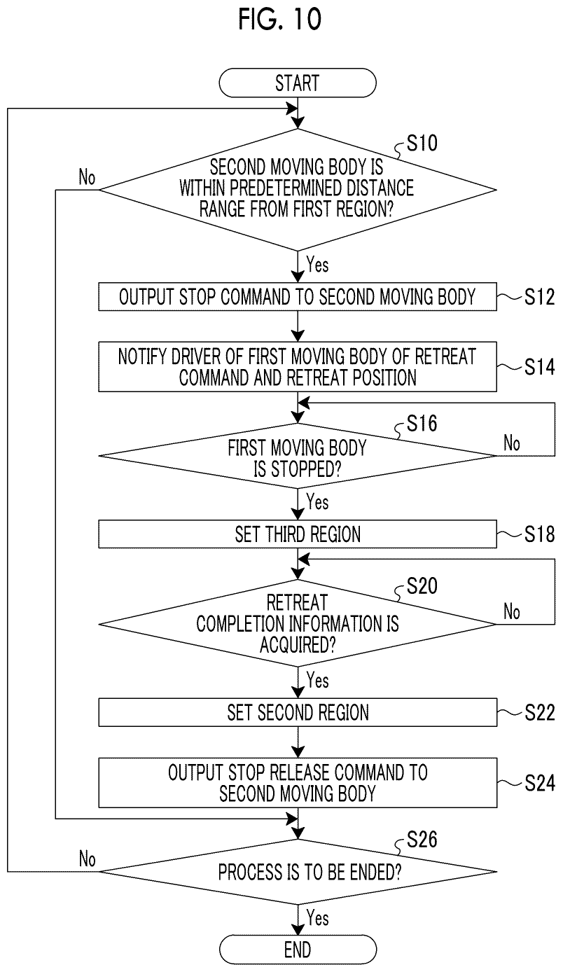

A flow of the processing contents of the movement control system 1 described above will be described. FIG. 10 is a flowchart illustrating a processing flow of the movement control system. The information processing device 14 sequentially acquires the first moving body information and the second moving body information from the first moving body 10A and the second moving body 10B via the moving body information acquisition unit 62, and sets the first region AR1 of the first moving body 10A while sequentially updating the first region AR1 via the region setting unit 64. Then, as shown in FIG. 10, the information processing device 14 determines whether the second moving body 10B is within a predetermined distance range from the first region AR1 of the first moving body 10A via the stop command unit 66 (step S10). In a case where the second moving body 10B is not within a predetermined distance range (step S10; No), the process proceeds to step S26. On the other hand, in a case where the second moving body 10B is within a predetermined distance range from the first region AR1 (step S10; Yes), the stop command unit 66 transmits the stop command to the second moving body 10B (step S12) to stop the movement of the second moving body 10B. In addition, the information processing device 14 sets the retreat position via the retreat command unit 68 and notifies the driver U of the first moving body 10A of the retreat command and the retreat position (step S14). Thereafter, the driver U moves the first moving body 10A to the retreat position and stops the first moving body 10A. After the retreat command is notified of, the information processing device 14 determines whether or not the first moving body 10A is stopped, based on the first moving body information (step S16). In a case where the first moving body 10A is not stopped (step S16; No), the process returns to step S16, and, in a case where the first moving body 10A is stopped (step S16; Yes), the information processing device 14 sets the third region AR3 (step S18) and switches the protection region to the third region AR3. Thereafter, when the information processing device 14 acquires the retreat completion information indicating that the first moving body 10A has stopped at the retreat destination (step S20; Yes), the information processing device 14 sets the second region AR2 (step S22) and switches the protection region to the second region AR2. When the retreat completion information is not acquired (step S20; No), the process returns to step S20. In addition, when the information processing device 14 sets the second region AR2, the information processing device 14 outputs the stop release command to the second moving body 10B (step S24) and resumes the movement of the second moving body 10B. Thereafter, the process proceeds to step S26. In a case where the present process is not to be ended (step S26; No), the process returns to step S10, and, in a case where the present process is to be ended (step S26; Yes), the present process is ended.

### Effects

As described above, a control method for a moving body according to a first aspect of the present disclosure includes a step of acquiring first moving body information including a position and a speed of a first moving body 10A that is a manned vehicle, a step of setting a first region AR1, where an unmanned vehicle is prohibited from entering, around the first moving body 10A based on the first moving body information, a step of acquiring second moving body information including a position of a second moving body 10B that is an unmanned vehicle, a step of stopping the second moving body 10B in a case where the position of the second moving body 10B indicated by the second moving body information is within a predetermined distance range from the first region AR1, a step of notifying a driver U of the first moving body 10A of a retreat command to retreat to another location in a case where the second moving body 10B has stopped, a step of acquiring retreat completion information indicating that the first moving body 10A has stopped at a retreat destination, and a step of, when the retreat completion information is acquired, setting a second region AR2, where an unmanned vehicle is prohibited from entering, around the first moving body 10A so as to be narrower than the first region AR1. According to the present embodiment, when the second moving body 10B is stopped, the retreat command is output to the first moving body 10A, and the driver U of the first moving body 10A is prompted to move to another location. As a result, the first moving body 10A moves away from the second moving body 10B, and the second moving body 10B can resume the movement, so that it is possible to appropriately eliminate or suppress the deadlock. Furthermore, when the retreat completion information is acquired, the protection region is reduced from the first region AR1 to the second region AR2, thereby suppressing the hindrance to the movement of another unmanned vehicle when the first moving body 10A is moved to the retreat destination.

A control method for a moving body according to a second aspect of the present disclosure is the control method for a moving body according to the first aspect, in which the second region AR2 has a length shorter than a length of the first region AR1 in a traveling direction of the first moving body 10A. By setting the second region AR2 in this manner, it is possible to suitably suppress the hindrance to the movement of another unmanned vehicle.

A control method for a moving body according to a third aspect of the present disclosure is the control method for a moving body according to the first aspect or the second aspect, and further includes a step of setting a third region AR3, where an unmanned vehicle is prohibited from entering, around the first moving body 10A so as to be narrower than the first region AR1 and wider than the second region AR2, in a case where the first moving body information indicates that the first moving body 10A is stopped after the retreat command is notified of and before the retreat completion information is acquired. By setting the third region AR3 in this manner, it is possible to suppress the interference with another unmanned vehicle without hindering the movement of the other unmanned vehicle as much as possible.

A control method for a moving body according to a fourth aspect of the present disclosure is the control method for a moving body according to the third aspect, in which the third region AR3 has a length shorter than a length of the first region AR1 and longer than a length of the second region AR2 in a traveling direction of the first moving body 10A. By setting the third region AR3 in this manner, it is possible to suppress the interference with another unmanned vehicle without hindering the movement of the other unmanned vehicle as much as possible.

A control method for a moving body according to a fifth aspect of the present disclosure is the control method for a moving body according to the fourth aspect, in which the third region AR3 has a length longer than lengths of the first region AR1 and the second region AR2 in a direction opposite to the traveling direction of the first moving body 10A. By setting the third region AR3 in this manner, it is possible to suppress the interference with another unmanned vehicle without hindering the movement of the other unmanned vehicle as much as possible.

A control method for a moving body according to a sixth aspect of the present disclosure is the control method for a moving body according to any one of the first aspect to the fifth aspect, and further includes a step of, in a case where the second moving body 10B has stopped, setting a retreat position of the first moving body 10A based on the position and a movement destination of the second moving body 10B, and a step of notifying the driver U of the first moving body 10A of information indicating the retreat position. By setting the retreat position, the first moving body 10A can be retreated to a position where the second moving body 10B can be appropriately avoided, thereby making it possible to appropriately eliminate or suppress the deadlock.

A control method for a moving body according to a seventh aspect of the present disclosure is the control method for a moving body according to the sixth aspect, in which, in the step of setting the retreat position, the retreat position is set based on at least one of the first moving body information and a movement destination of the first moving body. By setting the retreat position based on the information on the first moving body 10A as well, a position that is convenient for the first moving body 10A can be set as the retreat position.

A program according to an eighth aspect of the present disclosure causes a computer to execute a step of acquiring first moving body information including a position and a speed of a first moving body 10A that is a manned vehicle, a step of setting a first region AR1, where an unmanned vehicle is prohibited from entering, around the first moving body 10A based on the first moving body information, a step of acquiring second moving body information including a position of a second moving body 10B that is an unmanned vehicle, a step of stopping the second moving body 10B in a case where the position of the second moving body 10B indicated by the second moving body information is within a predetermined distance range from the first region AR1, a step of notifying a driver U of the first moving body 10A of a retreat command to retreat to another location in a case where the second moving body 10B has stopped, a step of acquiring retreat completion information indicating that the first moving body 10A has stopped at a retreat destination, and a step of, when the retreat completion information is acquired, setting a second region AR2, where an unmanned vehicle is prohibited from entering, around the first moving body 10A so as to be narrower than the first region AR1. According to the present disclosure, it is possible to appropriately eliminate or suppress the deadlock, and to suppress the hindrance to the movement of another unmanned vehicle.

An information processing device 14 according to a ninth aspect of the present disclosure includes a moving body information acquisition unit 62 that acquires first moving body information including a position and a speed of a first moving body 10A that is a manned vehicle and second moving body information including a position of a second moving body 10B that is an unmanned vehicle, a region setting unit 64 that sets a first region AR1, where an unmanned vehicle is prohibited from entering, around the first moving body 10A based on the first moving body information, a stop command unit 66 that stops the second moving body 10B in a case where the position of the second moving body 10B indicated by the second moving body information is within a predetermined distance range from the first region AR1, a retreat command unit 68 that notifies a driver U of the first moving body 10A of a retreat command to retreat to another location in a case where the second moving body 10B has stopped, and a retreat information acquisition unit 70 that acquires retreat completion information indicating that the first moving body 10A has stopped at a retreat destination. When the retreat completion information is acquired, the region setting unit 64 sets a second region AR2, where an unmanned vehicle is prohibited from entering, around the first moving body 10A so as to be narrower than the first region AR1. According to the present disclosure, it is possible to appropriately eliminate or suppress the deadlock, and to suppress the hindrance to the movement of another unmanned vehicle.

Although the embodiment of the present disclosure has been described above, the embodiment is not limited by the contents of the embodiment. In addition, the above-described components include those that can be easily assumed by those skilled in the art, those that are substantially the same, and those that are within a so-called equivalent range. Further, the above-described components can be combined as appropriate. Furthermore, various omissions, relocationments, or modifications of the above-described components can be made without departing from the concept of the above-described embodiment.

### REFERENCE SIGNS LIST

10: moving body
10A: first moving body
10B: second moving body
12: management device
14: information processing device
62: moving body information acquisition unit
64: region setting unit
66: stop command unit
68: retreat command unit
70: retreat information acquisition unit
AR1: first region
AR2: second region
AR3: third region

1. A control method for a moving body, comprising:
a step of acquiring first moving body information including a position and a speed of a first moving body that is a manned vehicle;
a step of setting a first region, where an unmanned vehicle is prohibited from entering, around the first moving body based on the first moving body information;
a step of acquiring second moving body information including a position of a second moving body that is an unmanned vehicle;
a step of stopping the second moving body in a case where the position of the second moving body indicated by the second moving body information is within a predetermined distance range from the first region;
a step of notifying a driver of the first moving body of a retreat command to retreat to another location in a case where the second moving body has stopped;
a step of acquiring retreat completion information indicating that the first moving body has stopped at a retreat destination; and
a step of, when the retreat completion information is acquired, setting a second region, where an unmanned vehicle is prohibited from entering, around the first moving body so as to be narrower than the first region.

2. The control method for a moving body according to claim 1,
wherein the second region has a length shorter than a length of the first region in a traveling direction of the first moving body.

3. The control method for a moving body according to claim 1, further comprising:
a step of setting a third region, where an unmanned vehicle is prohibited from entering, around the first moving body so as to be narrower than the first region and wider than the second region, in a case where the first moving body information indicates that the first moving body is stopped after the retreat command is notified of and before the retreat completion information is acquired.

4. The control method for a moving body according to claim 3,
wherein the third region has a length shorter than a length of the first region and longer than a length of the second region in a traveling direction of the first moving body.

5. The control method for a moving body according to claim 4,
wherein the third region has a length longer than lengths of the first region and the second region in a direction opposite to the traveling direction of the first moving body.

6. The control method for a moving body according to claim 1, further comprising:
a step of, in a case where the second moving body has stopped, setting a retreat position of the first moving body based on the position and a movement destination of the second moving body; and
a step of notifying the driver of the first moving body of information indicating the retreat position.

7. The control method for a moving body according to claim 6,
wherein, in the step of setting the retreat position, the retreat position is set based on at least one of the first moving body information and a movement destination of the first moving body.

8. A non-transitory computer-readable recording medium having stored thereon a program causing a computer to execute:
a step of acquiring first moving body information including a position and a speed of a first moving body that is a manned vehicle;
a step of setting a first region, where an unmanned vehicle is prohibited from entering, around the first moving body based on the first moving body information;
a step of acquiring second moving body information including a position of a second moving body that is an unmanned vehicle;
a step of stopping the second moving body in a case where the position of the second moving body indicated by the second moving body information is within a predetermined distance range from the first region;
a step of notifying a driver of the first moving body of a retreat command to retreat to another location in a case where the second moving body has stopped;
a step of acquiring retreat completion information indicating that the first moving body has stopped at a retreat destination; and
a step of, when the retreat completion information is acquired, setting a second region, where an unmanned vehicle is prohibited from entering, around the first moving body so as to be narrower than the first region.

9. An information processing device comprising:
a moving body information acquisition unit that acquires first moving body information including a position and a speed of a first moving body that is a manned vehicle and second moving body information including a position of a second moving body that is an unmanned vehicle;
a region setting unit that sets a first region, where an unmanned vehicle is prohibited from entering, around the first moving body based on the first moving body information;
a stop command unit that stops the second moving body in a case where the position of the second moving body indicated by the second moving body information is within a predetermined distance range from the first region;
a retreat command unit that notifies a driver of the first moving body of a retreat command to retreat to another location in a case where the second moving body has stopped; and
a retreat information acquisition unit that acquires retreat completion information indicating that the first moving body has stopped at a retreat destination,
wherein, when the retreat completion information is acquired, the region setting unit sets a second region, where an unmanned vehicle is prohibited from entering, around
the first moving body so as to be narrower than the first region.
